(19) United States
(12) Patent Application Publication
(10) Pub. No.: US 2025/0028568 A1
(43) Pub. Date: Jan. 23, 2025

(54) METHODS AND SYSTEMS FOR OPTIMIZING DISTRIBUTED COMPUTING NETWORK CONFIGURATION

(71) Applicant: Gluware IP, LLC, Sacramento, CA (US)

(72) Inventors: Stanislav Miskovic, San Jose, CA (US); Kyle Scarmardo, Dallas, TX (US); Jeffrey T. Boone, El Dorado Hills, CA (US)

(21) Appl. No.: 18/357,088

(22) Filed: Jul. 21, 2023

(51) Int. Cl. G06F 9/50

(52) U.S. Cl. CPC G06F 9/505; G06F 9/5072

(57) ABSTRACT

In one aspect, first data characterizing one or more constituent devices of a distributed computing network configured with a configuration structure comprising one or more configuration layers can be received. A subset of the one or more constituent devices can be determined based on the received first data. Second data characterizing at least one configuration discrepancy between each of the one or more constituent devices included in the determined subset can be determined by tokenizing one or more commands included in each of the one or more configuration layers used to configure each of the one or more constituent devices included in the determined subset and by identifying the at least one configuration discrepancy based on the tokenized one or more commands. Third data characterizing a predominant configuration profile across each of the one or more constituent devices included in the determined subset can be determined based on the tokenized commands. One or more modifications to at least one of the one or more configuration layers of the one or more constituent devices can be determined based on the second data and third data. Fourth data characterizing a revised configuration of the one or more constituent devices can be determined based on the determined one or more modifications. The fourth data can be provided to a network configuration device to cause the revised configuration to be applied to the one or more constituent devices. Related apparatus, systems, methods, techniques, and articles are also described.

### TECHNICAL FIELD

This disclosure relates generally to distributed computing network configuration, and, in particular, to optimizing one or more configurations of a distributed computing network.

### BACKGROUND

In some implementations of a highly complex, distributed computing network, the configuration of the distributed computing network can be largely inconsistent. This may occur when, for example, such a system is created through incremental upgrades of preexisting systems (as opposed to being created as a new system, from the ground up) and is subject to a comprehensive design review and/or a design overhaul prior to deployment. As a result, such an incrementally-upgraded system can feature inconsistencies in the configurations between one or more of their constituent parts, and these inconsistencies can result in decreased system reliability and security.

Resolving such inconsistencies in system configurations can be highly risky and very difficult to achieve without the occurrence of adverse impacts on system operation and performance. For example, some techniques for resolving system configuration inconsistencies can cause an entire system can be disrupted for an unknown amount of time. For large-scale distributed computing systems, such as internet service provider (ISP) networks, corporate networks, or cloud-based computer systems, this is unacceptable.

### SUMMARY

In general, methods and systems for optimizing distributed computing network configuration are provided.

In one aspect, first data characterizing one or more constituent devices of a distributed computing network configured with a configuration structure comprising one or more configuration layers can be received by at least one processor. A subset of the one or more constituent devices can be determined based on the received first data and using the at least one processor. Second data characterizing at least one configuration discrepancy between each of the one or more constituent devices included in the determined subset can be determined using the at least one processor, by tokenizing one or more commands included in each of the one or more configuration layers used to configure each of the one or more constituent devices included in the determined subset, and by identifying the at least one configuration discrepancy based on the tokenized one or more commands. Third data characterizing a predominant configuration profile across each of the one or more constituent devices included in the determined subset can be determined using the at least one processor and based on the tokenized commands. One or more modifications to at least one of the one or more configuration layers of the one or more constituent devices can be determined using the at least one processor and based on the second data and third data. Fourth data characterizing a revised configuration of the one or more constituent devices can be determined using the at least one processor and based on the determined one or more modifications. The fourth data can be provided to a network configuration device by the at least one processor to cause the revised configuration to be applied to the one or more constituent devices.

One or more of the following features can be included in any feasible combination. For example, the tokenizing of the one or more commands can include determining, for each command of the one or more commands, an array that includes at least one string and at least one value indicating a presence of the command within one of the one or more configuration layers. For example, the identifying of the at least one configuration discrepancy and the determining of the predominant configuration profile can include evaluating the at least one value of the tokenized command. For example, the determination of the one or more modifications can be based on the evaluation of the at least one value of the tokenized command. For example, the subset of the one or more constituent devices can be determined based on at least one of: a location of the one or more constituent devices, a vendor and model of the one or more constituent devices, a measure of similarity of connections of the one or more constituent devices exceeding a predetermined threshold, and a presence of shared configuration elements. For example, a graphical depiction characterizing the at least one configuration discrepancy can be determined, and the graphical depiction can be provided to a graphical user interface for display therein. For example, the fourth data can include prioritization data characterizing a ranking assigned to one or more portions of the revised configuration, the ranking can be based on a rate of occurrence of the at least one configuration discrepancy, and the revised configuration characterized by the fourth data can be based on the prioritization data. For example, the at least one configuration discrepancy can characterize an absence of a security command within one or more of the one or more configuration layers. For example, a graphical user interface that characterizes the determined one or more modifications and one or more of the one or more configuration layers can be determined using the at least one processor, and the graphical user interface can be provided to a display for depiction thereon using the at least one processor. For example, an auto-completion program that is configured to provide a graphical prompt characterizing a second, following portion of the one or more commands in response to the user inputting a first, preceding portion of the one or more commands can be determined based on the determined one or more modifications.

In another aspect, a system is provided and can include at least one programmable processor; and a non-transitory machine-readable medium storing instructions that, when executed by the at least one programmable processor, can cause the at least one programmable processor to perform operations. The operations can include: receiving, by least one processor, first data characterizing one or more constituent devices of the distributed computing network, each of the one or more constituent devices configured with a configuration structure comprising one or more configuration layers; determining, using the at least one processor, a subset of the one or more constituent devices based on the received first data; determining, using the at least one processor, second data characterizing at least one configuration discrepancy between each of the one or more constituent devices included in the determined subset, the second data determined by tokenizing one or more commands included in each of the one or more configuration layers used to configure each of the one or more constituent devices included in the determined subset and identifying the at least one configuration discrepancy based on the tokenized one or more commands; determining, using the at least one processor and based on the tokenized commands, third data characterizing a predominant configuration profile across each of the one or more constituent devices included in the determined subset; determining, using the at least one processor and based on the second data and third data, one or more modifications to at least one of the one or more configuration layers of the one or more constituent devices; determining, using the at least one processor and based on the determined one or more modifications, fourth data characterizing a revised configuration of the one or more constituent devices; and providing, by the at least one processor, the fourth data to a network configuration device to cause the revised configuration to be applied to the one or more constituent devices.

One or more of the following features can be included in any feasible combination. For example, the tokenizing of the one or more commands can include determining, for each command of the one or more commands, an array that includes at least one string and at least one value indicating a presence of the command within one of the one or more configuration layers. For example, the identifying of the at least one configuration discrepancy and the determining of the predominant configuration profile can include evaluating the at least one value of the tokenized command. For example, the determination of the one or more modifications can be based on the evaluation of the at least one value of the tokenized command. For example, the subset of the one or more constituent devices can be determined based on at least one of: a location of the one or more constituent devices, a vendor and model of the one or more constituent devices, a measure of similarity of connections of the one or more constituent devices exceeding a predetermined threshold, and a presence of shared configuration elements. For example, the operations can further comprise determining a graphical depiction characterizing the at least one configuration discrepancy; and providing the graphical depiction to a graphical user interface for display therein. For example, the fourth data can include prioritization data characterizing a ranking assigned to one or more portions of the revised configuration, and the ranking can be based on a rate of occurrence of the at least one configuration discrepancy, and the revised configuration characterized by the fourth data can be based on the prioritization data. For example, the at least one configuration discrepancy characterizes an absence of a security command within one or more of the one or more configuration layers. For example, the operations can further include determining, using the at least one processor, a graphical user interface that characterizes the determined one or more modifications and one or more of the one or more configuration layers, and providing, using the at least one processor, the graphical user interface to a display for depiction thereon.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 is a process flow diagram illustrating an example process 100 of some implementations of the subject matter described herein that can provide for improved detection, analysis, and resolution of inconsistencies in the configuration of a distributed computing network;

FIG. 2 is a schematic illustration of an exemplary system that can provide for detection, analysis, and resolution of inconsistencies in the configuration of a distributed computing network;

FIG. 3 is a series of first views of an exemplary graphical user interface in accordance with some implementations of the subject matter described herein;

FIG. 4 is a second view of an exemplary graphical user interface in accordance with some implementations of the subject matter described herein;

FIG. 5 is a third view of an exemplary graphical user interface in accordance with some implementations of the subject matter described herein;

FIG. 6 is a fourth view of an exemplary graphical user interface in accordance with some implementations of the subject matter described herein;

FIG. 7 is a fifth view of an exemplary graphical user interface in accordance with some implementations of the subject matter described herein;

FIG. 8 is a sixth view of an exemplary graphical user interface in accordance with some implementations of the subject matter described herein;

FIG. 9 is a seventh view of an exemplary graphical user interface in accordance with some implementations of the subject matter described herein; and

FIG. 10 is an illustrative diagram of an exemplary computing system in accordance with some implementations of the subject matter described herein.

### DETAILED DESCRIPTION

It can be advantageous to streamline configurations of complex distributed computing systems (e.g., network systems/infrastructures where components of the program and data depend on multiple sources). For example, it can be beneficial to centralize management planes of systems, e.g., instead of configuring each device individually, configurations can be made and verified at a central location (usually called a system controller) and then distributed to individual devices in the system. Additionally, configurations themselves can become more streamlined through the use of configuration policies. An individual policy can remove inconsistencies in one or more parts of a configuration. For example, a policy that asks for device access to be authenticated and authentication credentials never be kept in plain text, results in a collection of configuration commands that should be present on all devices. Various configuration tools can operationalize the effort of streamlining configurations have been deployed in computer networks or IT infrastructures. Some of these tools can distribute configurations, some of these tools can enable shared formatting of configuration parameters, and some of these tools can enable system scaling by increasing the number of similarly configured (virtual) devices.

While such tools may be indeed sufficient to streamline a newly deployed system, many systems are not newly created from the ground up and are instead built through incremental upgrades of preexisting systems that can inherit inconsistencies in system configurations from preexisting system states and/or preexisting system settings. Addressing such inconsistencies in system configurations can be highly risky and very difficult to achieve without the occurrence of adverse impacts on system operation and performance. For example, some techniques for resolving system configuration inconsistencies can cause an entire system can be disrupted for an unknown amount of time.

In some implementations of the subject matter described herein, a computing device's ability to address inconsistencies in the configuration of the distributed computing network may be improved by detecting and analyzing the inconsistencies to determine and implement one or more modifications to the configuration of the distributed computing network that address the inconsistencies. For example, in some implementations, one or more constituent components (e.g., devices) of the distributed computing network in which configuration inconsistencies may be present can be determined, and the determined constituent components can be analyzed to identify any configuration inconsistencies present in the determined constituent components. To identify such inconsistencies, various functional blocks of configurations (e.g., a block describing access control lists, a block describing physical settings of interfaces, etc.) present within one or more layers of the configurations can be inspected. For example, for each of the determined constituent parts, one or more commands can be analyzed for each configuration layer, and the one or more commands can be tokenized by determining a token array that includes strings and values for and characterizing each command. The configuration inconsistencies can accordingly be identified by analyzing the token array.

For example, in some implementations of the subject matter described herein, one or more predominant configurations of the distributed computing network can be determined using the token array, and one or more modifications to the configurations of one or more of the constituent components of the distributed computing network can be determined based on the determined predominant configurations and the identified configuration inconsistencies. Data characterizing a revised configuration of one or more constituent components of the distributed computing network can be determined based on the determined modifications, and the revised configuration data can be transmitted to a network configuration device for implementation in the one or more constituent components of the distributed computing network. Configuration inconsistencies in the distributed computing network can therefore be resolved with the use of less computational resources than would otherwise be required with existing configuration discrepancy resolution techniques, and the operation of the distributed computing network can be improved as a result.

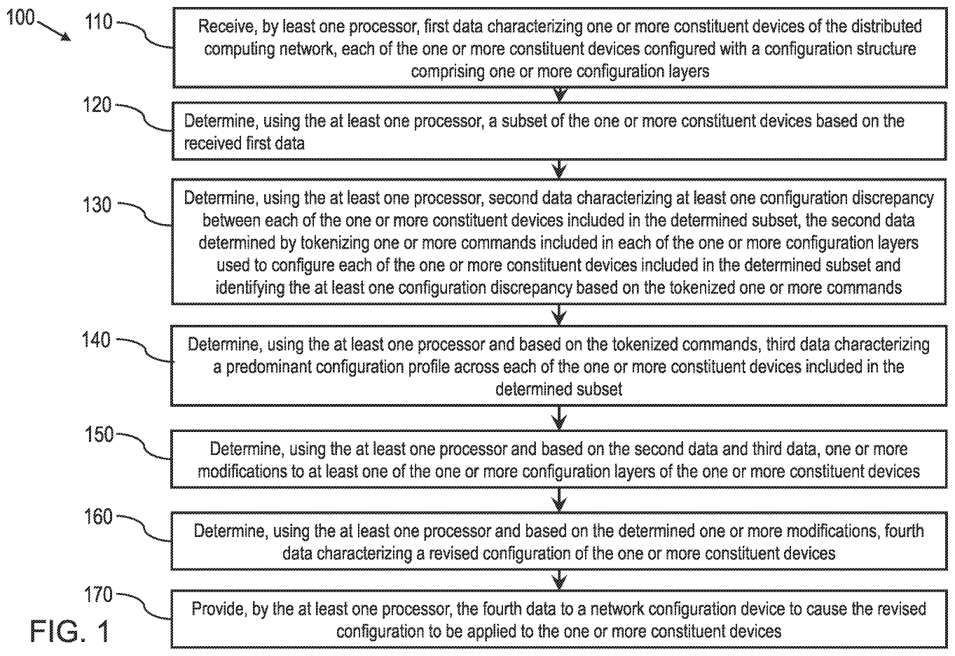

FIG. 1 is a process flow diagram illustrating an example process 100 of some implementations of the subject matter described herein that can provide for improved detection, analysis, and resolution of inconsistencies in the configuration of a distributed computing network.

At 110, first data characterizing one or more constituent devices of a distributed computing network can be received by at least one processor. In some implementations, the one or more constituent devices can include computer network components such as a wide area network (WAN) gateway, a file server, a local area network (LAN), personal computers, peripheral devices (login, print, other services, etc.), and the like. The first data can characterize one or more aspects of the constituent device(s). In some implementations, for example, the first data can characterize a location of the constituent device(s) (e.g., city, company office, network zone, and/or a cloud provider and zone), a vendor and/or model of the device(s), one or more ports of the device(s) used to connect to segment(s) and/or zone(s) of the network, one or more ports of the device(s) used to connect to neighboring device(s), a presence of certain shared configuration elements (e.g., configurations of similar services, PostgreSQL databases, BGP routing settings, etc.), and the like.

In some implementations, the one or more constituent devices can be configured with a multi-layer configuration structure using one or more configuration layers such that configuration details are specified with an increasing level of detail and/or complexity with each successive layer. For example, in a first, “top-most” configuration layer, various parameters/protocols can be specified, such as hostname definitions, or declarations of redundancy and failover protocols, declarations of routing and communication protocols, and the like. In a second configuration layer “below” the first configuration layer, settings for the parameters specified in the first configuration layer can be specified. For example, a redundancy group ID can be specified in the second configuration layer for a redundancy protocol specified in the first layer. In a third configuration layer “below” the second configuration layer, IP addresses of servers in the redundancy group corresponding to the redundancy group ID specified in the second configuration layer can be specified. As such, aspects of the configuration can be specified at successive configuration layers with a level of specificity and/or complexity that increases until a set of commands and/or parameter values is found at some level without any further configuration layers. In some implementations, each configuration layer can be codified and identified with the use of one or more line indentations in the syntax of the configuration code and such that the number of line indentations characterizes the configuration layer to which the configuration code belongs. As such, with reference to the example provided above, code corresponding to the first configuration layer may not feature any line indentations in the configuration syntax. Code corresponding to the second configuration layer may feature one line indentation in the configuration syntax, code corresponding to the third configuration layer may feature two line indentations in the configuration syntax, and so on. In some implementations, users may also use other methods for specifying configuration layers, such as by specifying other configuration layer delimiters or format templates.

The following are some examples of configurations that may be used in distributed computing networks, one or more constituent devices of such networks, database configurations, automation tools, and the like:

Example 1 (an exemplary configuration present in an exemplary automation tool)—A first configuration layer can be provided that specifies applicability of the configuration to all hosts, that it is unnecessary to collect variables about these hosts, and at this level, that the configuration can define tasks. A second configuration layer below the first configuration layer can be provided that specifies that a Windows user should be added, and a third configuration layer below the second configuration layer can be provided that specifies parameters for that user. Below is some exemplary syntax that codifies this configuration:

```
- name: Add a user
  hosts: all
  gather_facts: false
  tasks:
    - name: Add User
      win_user:
          name: ansible
        password: “pass12345!”
        state: present
```

Example 2 (an exemplary configuration present in an exemplary dynamic host configuration protocol (DHCP) server)—A first configuration layer can be provided that specifies several shared DHCP properties: a gateway, a subnet mask, a domain name, and a DNS server, as well as two hosts for which additional configuration details are to be set in successive layers. A second configuration layer below the first configuration layer can be provided that specifies additional configuration parameters for hosts dev1 and dev2. Below is some exemplary syntax that codifies this configuration:

```
group {
  option routers 10.0.1.254;
  option subnet-mask 255.255.255.0;
  option domain-search “domain.com”;
  option domain-name-servers 10.0.1.1;
  host dev1 {
    option host-name “dev1.domain.com”;
    hardware ethernet 00:A1:78:76:43:AB;
    fixed-address 10.0.1.11;
  }
  host dev2 {
    option host-name “dev2.domain.com”;
    hardware ethernet 00:A1:78:31:7E:0D;
    fixed-address 10.0.1.11;
  }
}
```

Example 3 (an exemplary configuration present on an exemplary network operating system platform)—A first configuration layer can be provided that declares BGP routing and that the router is to be in the autonomous system 54321. A second configuration layer below the first configuration layer can be provided that declares a BGP identifier/IP address of the router and template configurations to be applied to various BGP neighbor sessions, etc. Below is some exemplary syntax that codifies this configuration.

```
router bgp 54321
  router-id 10.0.0.1
  template peer Amazon2DMZ
    remote-as 12345
    password 3 0abc34de56f78001
    timers 5 15
    address-family ipv4 unicast
      send-community
      route-map Amazon2DMZ in
      route-map DMZ2Amazon out
      soft-reconfiguration inbound always
  template peer Azure2DMZ
    remote-as 12456
    ebgp-multihop 4
    timers 5 15
    address-family ipv4 unicast
      send-community
      route-map DMZ2Azure out
      soft-reconfiguration inbound always
```

At 120, a subset of the one or more constituent devices can be determined using the at least one processor and based on the received data. For example, the at least one processor can analyze one or more of the aspect(s) of the device(s) described above and characterized by the received data. Based on this analysis, the device(s) can be clustered together according to a measure of similarity to form the subset, and the subset can be updated in real-time based on similarities in configurations identified via one or more of the techniques described elsewhere herein (e.g., via analysis of token arrays as described below). In some implementations, such as a scenario in which the constituent device(s) have been previously identified, the device(s) can be clustered in accordance with predetermined analysis criteria. For example, a user can specify a site or department associated with constituent devices of interest, and the predetermined analysis criteria can characterize the specified site or department. For example, the subset of the one or more constituent devices can be clustered based on one or more device properties, such as site, department, vendor, model, and/or operating system versions, and the like. In some implementations, the one or more device properties can be specified as spans or sets (e.g., company sites should be {NY, LA, SF}, operating system versions should be larger than 12.3, etc.) In some implementations, any set of properties can be determined for clustering, and any generic clustering algorithm (e.g., K-means, etc.) with any chosen clustering/similarity metric based on the chosen properties (such as Euclidian distance for numeric properties, Edit/Levenshtein for text properties, Jaccard index for properties that are sets, etc.) In some implementations, such as a scenario in which common schemes of configurations of devices are determined,

At 130, second data characterizing at least one configuration discrepancy between each of the one or more constituent devices included in the determined subset can be determined using the at least one processor. In some implementations, an exemplary configuration discrepancy can include a discrepancy in the enablement of a type of functionality across the constituent devices in the distributed computing network. For example, a certain type of functionality can be configured in a first device of the constituent devices but omitted from a configuration of a second device of the constituent devices. For example, access authentication functionality may be enabled and configured in the first device, however, the access authentication functionality may be disabled, or enabled but not configured, in the second device. In some implementations, an exemplary configuration discrepancy can include a discrepancy in the completeness of a configuration of one or more of the constituent devices. For example, a certain type of functionality within a constituent device may not be fully configured for the functionality to be operational. For example, the routing of a constituent device may be configured, however default routes of the routing may not be configured (or sufficiently configured) to be operational.

In some implementations, an exemplary configuration discrepancy can include a discrepancy between an actual process by which one or more of the constituent devices is configured and a target process by which one or more of the constituent devices is configured. For example, an actual process for configuring an access control list can include individually configuring on each of the constituent devices of the distributed computing network, and, a target process for configuring such an access control list can include configuring a single access control policy and applying the policy to all of the constituent devices of the distributed computing network in which a manner that computational resources are more efficiently utilized. In some implementations, an exemplary configuration discrepancy can include a discrepancy between an actual configuration for one or more of the constituent devices and a target configuration for one or more of the constituent devices that maximizes the performance of one or more of the constituent devices and/or more efficiently utilized the distributed computing network as a whole. In some implementations, an exemplary configuration discrepancy can include a discrepancy between a configuration parameter value for a first constituent device of the distributed computing network and a configuration parameter value for one or more other constituent devices of the distributed computing network. For example, a packet size parameter (e.g., maximum transmission unit (MTU) size parameter) for the first constituent device may be set to 9000 bytes, but a packet size parameter (e.g., MTU size parameter) for the one or more other constituent devices may be set to 1500 bytes.

In some implementations, a configuration discrepancy between a plurality of the constituent devices may be based on a characteristic of each of the plurality of the constituent devices. For example, a first constituent device including an access router may feature a configuration that differences from a configuration of a second constituent device including a core router due to one or more differences between operational requirements of the core router and operational requirements of the access router. For example, a first constituent device including a communication switch may be configured differently than a second constituent device including a firewall due to the varying operational requirements of the communication switch and the firewall. Similarly, one or more constituent devices utilizing a Border Gateway Protocol (BGP) routing protocol may be configured differently than one or more constituent devices utilizing an Open Shortest Path First (OSPF) routing protocol in order to optimize performance of the device for the protocol utilized.

In some implementations, the second data can be determined by tokenizing one or more commands or parameters included in each of the one or more configuration layers used to configure each of the one or more constituent devices included in the determined subset. For example, for each device within the determined subset, and for each configuration layer, all commands and/or parameters within the configuration layer are read, and data characterizing the device to which the commands and/or parameters are applied is also determined and associated with each command and/or parameter read. Each command and/or parameter read can be tokenized by determining a token array that includes strings and values for and characterizing each command and/or parameter. In some implementations, the strings included in the array can include a command and/or parameter itself and/or characters within the command and/or parameter (e.g., command names, names of all command options, etc.), and the values included in the array can include values of all parameters in a command. In some implementations, strings and values may be separated within the array by use of delimiting characters such as space/blank characters (“ ”), or colons (“:”), or any other delimiter characters that may be specified by the user. As such, the resulting array preserves the order of strings, such that the first value in the array is the first string found in the command, etc., and thereby command context and meaning is preserved for all parts of a command. For example, the command “neighbor iBGP timers 3 10” found at a device Dev1 can be tokenized as follows [“neighbor”, “iBGP”, “timers”, “3”, “10” ] and this resulting token array can also be associated with Dev1, i.e., we could record this as a map {[“neighbor”, “iBGP”, “timers”, “3”, “10” ], Dev1}.

Next, for each tokenized command, the number of devices at which each of token array values is found in a given command/command type at a given index in the token array can be determined. With reference to the example described above, the number of devices in the determined subset at which the array string “neighbor” is found as the first string in commands can be determined, the number of devices in the determined subset at which the array string “iBGP” is found as the second string in neighbor commands can be determined, and so on. The outcome of this determination may be presented as {[“neighbor”: 90, “iBGP”: 10, “timers”: 80, “3”: 80, “10”: 20], Dev1}. As such, in an example where the determined subset includes 100 constituent devices, this determination indicates that the command “neighbor” is very common because it was found on 90 devices; this also indicates that “timer” option commonly occurs as a third parameter of the neighbor command on 80 devices, and that a common value of the first timer is 3 as found on 80 devices. However, this also indicates that command parameters “iBGP” and 10 which we found on the device Dev1 are less common. This can be used to determine a modification to the configuration of a configuration layer of a device of the determined subset as described in detail below. For example, analysis of the tokenized strings can yield a determination that “iBGP” and 10 parameters may need to be changed, and suggestions for optimized values of these parameters may be determined as a result of the analysis as well.

The token array can be used to determine relative commonality and rarity of commands present in the configurations of determined subset of constituent devices. The values of the array can be normalized in order to make occurrences of all parameters within commands of the determined subset mutually comparable. For example, the values can be normalized by dividing counts of the array values by the total number of observed devices. In the previous example, the result of such normalization would be: {[“neighbor”: 0.9, “iBGP” 0.1, “timers”: 0.8, “3”: 0.8, “10” 0.2], Dev1}. In some embodiments, a determination of whether an array value is “common” or “rare” across the subset can be made based on whether the count of occurrence of an array value within arrays across the subset exceeds or is less than a predetermined threshold. For example, an array value may be deemed “common” if it is present in arrays corresponding to more than 60% of observed devices within the subset, e.g., thrsholdMaxOccurrence is set to 0.6. Similarly an array value may be deemed “rare” if it is present in arrays corresponding to less than 25% of observed devices within the subset, e.g., thrsholdMinOccurrence is set to 0.25. In some implementations thrsholdMaxOccurrence and thrsholdMinOccurrence may be user-set parameters. In some implementations, for each tokenized command, two additional metrics, the maximum and the minimum occurrence rates of all array values corresponding to the command, can be determined. With reference to the previous example, maxTokenOccurrence=0.9, which corresponds to the token “neighbor”, and the minTokenOccurrence=0.1, which corresponds to the token “iBGP”. An exemplary data structure characterizing the above-described determinations may be presented as follows: {[“neighbor”: 0.9, “iBGP” 0.1, “timers”: 0.8, “3” 0.8, “10”: 0.2], maxTokenOccurrence 0.9, minTokenOccurrence 0.1, Dev1}.

The process described above can be repeated at each configuration layer. However, in some implementations, the process can be skipped for a given configuration layer based on an instruction provided by a user (e.g., a network administrator). If the user declines to apply a command at a given configuration layer, the command is not applied to configuration layers below the configuration layer that is skipped. Such commands would not be tokenized, scored or proposed for configuration modifications because they cannot be implemented without their “parent” command.

In some implementations, the at least one configuration discrepancy can be determined based on the tokenized one or more commands and using the at least one processor. For example, in some implementations, a command present in a configuration of a device in the determined subset may be determined to be a configuration discrepancy when an array value corresponding to the command is deemed “rare” as described above.

At 140, third data characterizing a predominant configuration profile across each of the one or more constituent devices included in the determined subset can be determined using the at least one processor. For example, in some implementations, one or more commands present in a configuration of a device in the determined subset may be determined to be part of a predominant configuration profile when an array value corresponding to the command is deemed “common” as described above. The third data can characterize the one or more commands determined to be “common.”

At 150, one or more modifications to at least one of the one or more configuration layers of the one or more constituent devices can be determined using the at least one processor and based on the second and third data. For example, in some implementations, commands present in the configurations of the determined subset of constituent devices that are associated with a maxTokenOccurrence metric larger than the thrsholdMaxOccurrence threshold can be determined as being “common,” and one or more modifications to at least one of the one or more configuration layers of the one or more constituent devices can be determined. The one or more modifications can include the addition of the commands determined as being “common.” When more than one modification is determined, a ranking of the determined modifications can also be determined. The determination of the ranking of the determined modifications can be based on a minTokenOccurrence metric associated with the command(s) included in the determined modification. For example, the lower the value of this metric for a given command, the lower the ranking of the command in the suggestions list. As an illustrative example, a ranked listing of determined modifications for the “neighbors” command referenced above may be determined and presented as follows:

| | |
|---|---|
| 1. | [“neighbor” : 0.9, “20.20.0.1” : 0.4, “timers” : 0.8, “3” : |
| | 0.8, “30” : 0.8], maxTokenOccurrence : 0.9, |
| | minTokenOccurrence : 0.4 |
| 2. | [“neighbor” : 0.9, “30.30.0.1” : 0.3, “timers” : 0.8, “3” : |
| | 0.8, “10” : 0.2], maxTokenOccurrence : 0.9, |
| | minTokenOccurrence : 0.2 |
| 3. | [“neighbor” : 0.9, “iBGP” : 0.1, “timers” : 0.8, “3” : 0.8, |
| | “10” : 0.2], maxTokenOccurrence : 0.9, minTokenOccurrence : |
| | 0.1 |

In some implementations, modifications can be determined for devices that have commands with the value of minTokenOccurrence metric below the thrsholdMinOccurrence threshold, meaning the command that is the subject of the determined modification is very rare or the command is relatively common across devices in the determined subset but features a rare parameter value. In the instance of the command of the configuration being very rare, e.g., the subcase where maxTokenOccurrence metric is lower than the thrsholdMinOccurrence threshold, the determined modification may include the removal of such commands from the configuration. In some implementations, where commands have been determined to be reasonably common (thrsholdMinOccurrence<maxTokenOccurrence≤thrsholdMaxOccurrence) but have rare parameter values (minTokenOccurrence≤thrsholdMinOccurrence), we would suggest potentially removing such commands or modifying their rare parameters with more common ones. In some implementations, where commands are deemed to be common (maxTokenOccurrence>thrsholdMaxOccurrence) but with rare parameter values (minTokenOccurrence≤thrsholdMinOccurrence), the determined modification can include that such parameter values be replaced with the ones identified as being common, e.g., parameter values having higher normalized count metrics when present in the command under examination.

At 160, fourth data characterizing a revised configuration of the one or more constituent devices can be determined using the at least one processor and based on the determined one or more modifications. In some implementations, whole configurations or parts of configurations (such as configuration parts related to IP address assignments and default gateway settings) can be pre-assembled for implementation in the one or more constituent devices. In some implementations, to pre-assemble the configurations or parts of configurations, the token array can be modified to characterize the one or more determined modifications, and the modified token array can be de-tokenized back to command and/or parameter form such that the command and/or parameter is modified consistent with the determined one or more modifications.

At 170, the fourth data can be provided by the at least one processor to a network configuration device to cause the revised configuration to be applied to the one or more constituent devices. For example, the fourth data can be provided to network automation tools such as Gluware RPA, which can rewrite configurations in accordance with the revised configuration characterized by the fourth data.

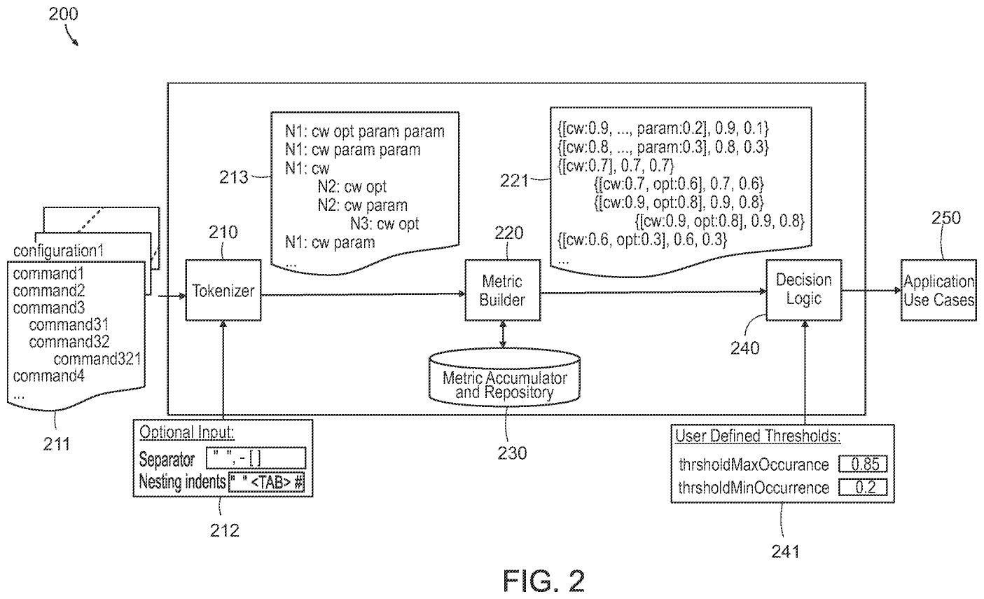

FIG. 2 is a schematic illustration of an exemplary system 200 that can provide for detection, analysis, and resolution of inconsistencies in the configuration of a distributed computing network. As shown, the system 200 includes a tokenizer 210 can that can receive data 211 characterizing one or more constituent devices of a distributed computing network (e.g., the first data described above with respect to FIG. 1). As shown, the data 211 can characterize a multi-layer configuration structure for one or more of the constituent devices, and the configuration structure can include one or more commands used in the operation and/or configuration of the one or more constituent devices. The tokenizer 210 can tokenize one or more commands or parameters included in each of the one or more configuration layers characterized by the data 211 by determining a token array 213 that includes strings and values for and characterizing each command and/or parameter. As shown, the token array 213 can include command words (indicated by “cw” in FIG. 2), options (indicated by “opt” in FIG. 2), and parameters/parameter values (indicated by “param” in FIG. 2). In addition, the tokenizer 210 can identify and assign levels of nesting to each tokenized command (e.g., N1, N2, N3, etc. as shown in FIG. 2). The tokenizer 210 can also receive one or more input parameters 212 that allow specification of aspects of the formatting of the token array 213 and/or identification of aspects of the one or more configuration layers characterized by the data 211. In some implementations, the input parameters 212 can override default aspects of the formatting of the token array 213 previously specified in the tokenizer 210. For example, such input parameters 212 can include separator characters (e.g., delimiting characters such as space/blank characters (“ ”), or colons (“:”), or other characters as shown in FIG. 2) that can be used by the tokenizer 210 to indicate separation of strings/values within the token array 213 and/or separation of configuration layers characterized by the data 211. Additionally, such input parameters 212 can include nesting indentation parameters/characters that allow the tokenizer 210 to identify separation of configuration layers characterized by the data 211.

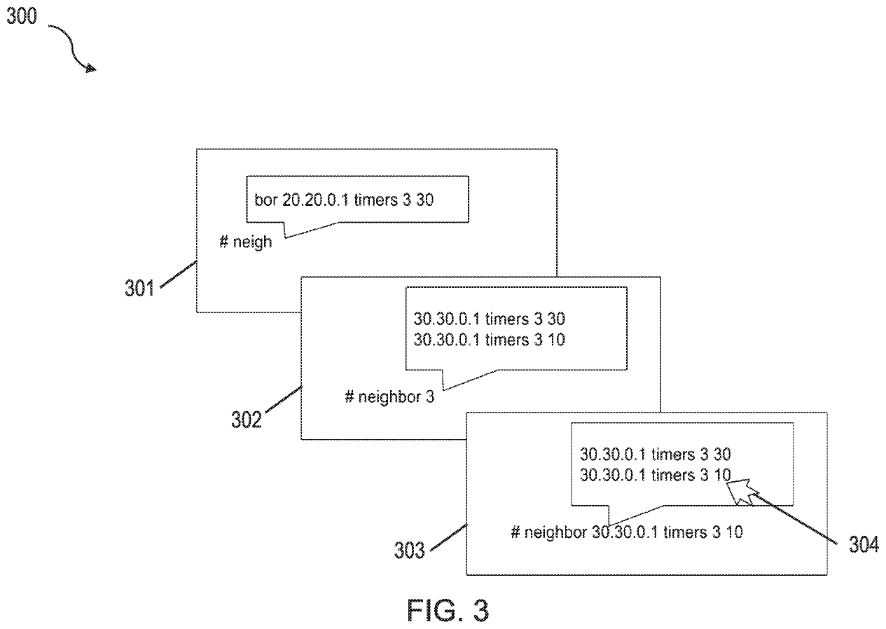

As shown in FIG. 2, the system 200 can also include a metric builder 220 that can determine one or more metrics based on the token array 213, such as one or more of the metrics described above with respect to FIG. 1. The metrics builder 220 can generate a data structure 221 that characterizes the determined metrics, and the determined metrics can be provided to a metric accumulator and repository 230 including an electronic database configured to store the determined metrics and/or update previously stored metrics. The data structure 221 can be provided to a decision logic 240 that is configured to evaluate the data structure 221. The data structure 221 can be evaluated by the decision logic 240 against one or more user-defined thresholds 241 for the metrics determined by the metrics builder 220 and characterized by the data structure 221. The output of the decision logic 240 can be provided for use in one more application use cases 250 as described in further detail below with respect to FIGS. 3-9.

In some implementations, one or more aspects of the process 100 described above can be used to provide assistance in configuring a distributed computing network by, for example, providing for auto completion of commands provided to a centralized network controller. FIG. 3 illustrates a series 300 of an example graphical user interface for creating commands featuring this functionality. More specifically, one or more common values of parameters (such as IP gateways, IP addresses, or numeric thresholds, and the like) or the rest of the command syntax to a user (e.g., network administrator) can be automatically suggested as the administrator progressively types the command as shown in each instance 301 to 303 of the series 300. In some implementations, the user can select a proposed value (as illustrated by hovering over the proposed value with a cursor 304 and selecting the proposed value. The proposed values presented in the graphical user interface can be determined based on one or more aspects of the process 100 described above. In some implementations, the proposed values can be ranked. For example, the proposed values can be ranked based on a rate of occurrence within configurations of the system.

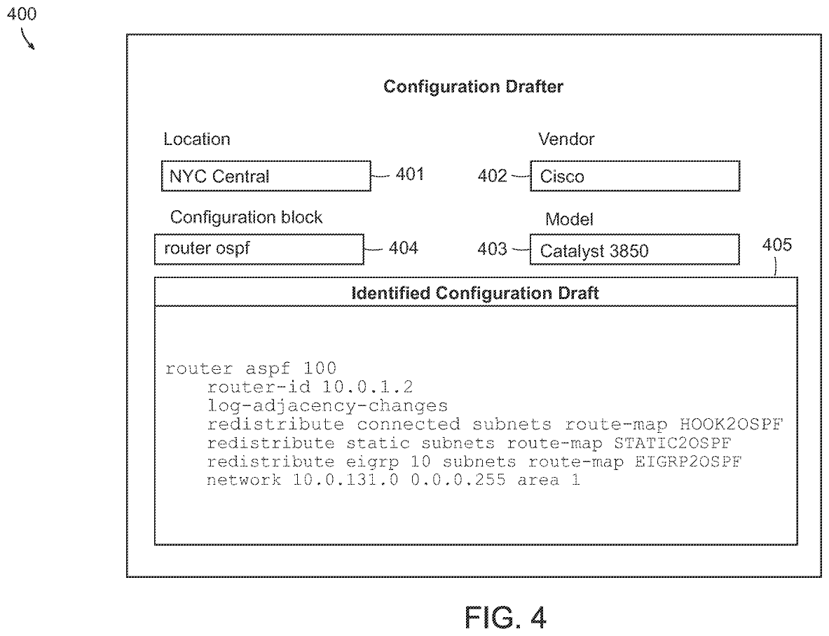

In some implementations, one or more aspects of the process 100 described above can be used to provide assistance in configuring a distributed computing network by, for example, outputting one or more portions of a configuration of the distributed computing network and/or a constituent device of the distributed computing network. FIG. 4 illustrates an example graphical user interface 400 for creating one or more such portions. As shown, the interface 400 includes one or more input fields 401-404 that allow a user of the graphical interface (e.g., a network administrator) to specify a site location, a constituent device vendor, a constituent device model, and a configuration block, respectively. In some implementations, the interface 400 can include additional input fields to allow users to specify configurations for analysis using the token array analysis techniques described above. After these parameters have been received via the graphical user interface 400, the system can perform one or more of the steps described above with respect to process 100 to determine and output a configuration skeleton 405 for a given device consisting of common commands and command parameter values identified in a given part of the network/system. In some embodiments, the graphical user interface 400 can incorporate one or more of the auto-completion capabilities described above with respect to FIG. 3.

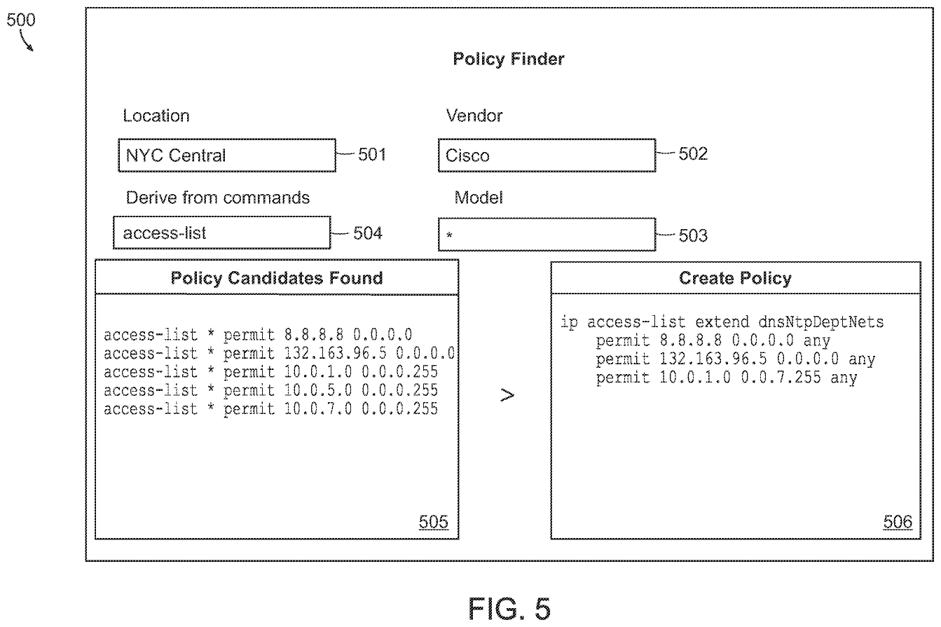

In some implementations, one or more aspects of the process 100 described above can be used to provide assistance in configuring a distributed computing network by, for example, determining a configuration policy featuring one or more common configuration parameters. For example, in some implementations, all common rules in access control lists can be identified and a common access control policy can be determined based on the identified common rules. For example, the access control policy can be created from access control commands that are found to be common on many devices, but belong to various access controlled lists. Similarly, in some implementations, common logging practices can be identified and a logging policy can be determined based on the identified common logging practices. And, similarly, in some implementations, common sets of traffic classification and QoS commands can be identified, and a traffic classification/QoS policy can be determined from the identified common sets. FIG. 5 illustrates an example graphical user interface 500 that permits a user to create such a policy. As shown, the interface 500 includes one or more input fields 501 to 504 that allow a user of the graphical interface (e.g., a network administrator) to specify a site location, a constituent device vendor, a constituent device model, and a target configuration parameter that can be used to specify common configuration parameters (in this example, the configuration parameter is an access control command) respectively. In some implementations, the interface 500 can include additional input fields to allow users to specify devices and/or configurations for analysis using the token array analysis techniques described above. As shown, based on the information specified in the input fields 501 to 504, the graphical user interface 500 can display a tokenized list 505 of the access control commands that displays values of the access control commands that that are determined to be common across configurations, and replaces other, less common tokens with a “*” wildcard. In some implementations, the graphical user interface 500 can also include a configuration policy window 506 that provides a suggested configuration policy based on the tokenized list of the access control commands.

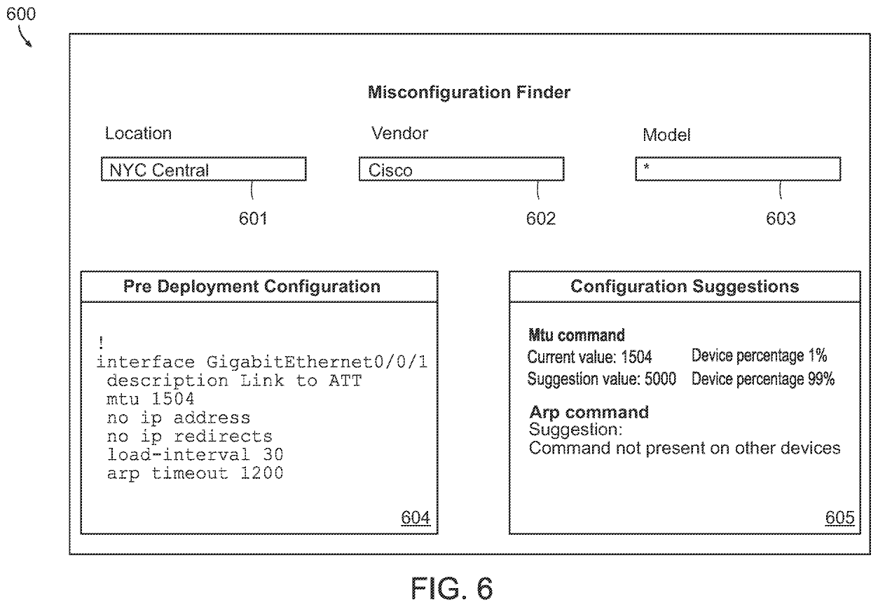

In some implementations, one or more aspects of the process 100 described above can be used to provide assistance in configuring a distributed computing network by, for example, evaluating existing or pre-deployment configurations to determine whether there are any errors that could cause the distributed computing network (or one or more of its constituent devices) to be misconfigured. FIG. 6 illustrates an example graphical user interface 600 for evaluating existing or pre-deployment configurations for misconfiguration. As shown, the graphical user interface 600 includes input fields 601 to 603 that allow a user of the graphical interface (e.g., a network administrator) to specify a site location, a constituent device vendor, and a constituent device model respectively. In some implementations, the interface 600 can include additional input fields to allow users to specify devices and/or configurations for analysis using the token array analysis techniques described above. Based on the information provided to input fields 601 to 603, the graphical user interface 600 can display, in a pre-deployment configuration window 604, one or more discrepancies in configurations and configuration parameters. And, based on the information provided to input fields 601 to 603, the graphical user interface 600 can display, in a configuration suggestions window 605, one or more suggested revisions to the supplied pre-deployment configuration that can result in a minimized risk of misconfiguration. For example, with reference to graphical user interface 600, the MTU parameter value of 1504 present in the observed configuration is indicated as being present only in 1% of other configurations/interfaces corresponding to the site location, constituent device vendor, and constituent device model specified via input fields 601-603. In contrast, the MTU value of 1500 is indicated as being present at 99% of such other interfaces/devices. Another kind of suggestion is given for the configuration of ARP timeouts, where the proposed solution provided in the configuration suggestions window suggests that no other interfaces/devices corresponding to the site location, constituent device vendor, and constituent device model specified via input fields 601-603 has such a command, e.g., not only that the value of ARP timeout parameter differs, but the entire command could not be found.

In some implementations, one or more aspects of the process 100 described above can be used to provide assistance in configuring a distributed computing network by, for example, providing functionality for enforcing a reference configuration. This functionality provides an opposite effect of that of the “prevention of misconfiguration” functionality described above with respect to FIG. 6. Here, the user supplies a reference configuration to which other devices in the network should align. Then, the system tokenizes the supplied configuration and starts comparing it with configurations in a given part of the network. The result is that the proposed invention identifies devices and parts of deployed configurations which need to be changed, prioritizes changes that need to be done first—such as, the devices that contain commands and command parameters that differ from the supplied reference configuration and have higher occurrence metric values in the network can be suggested for a change first.

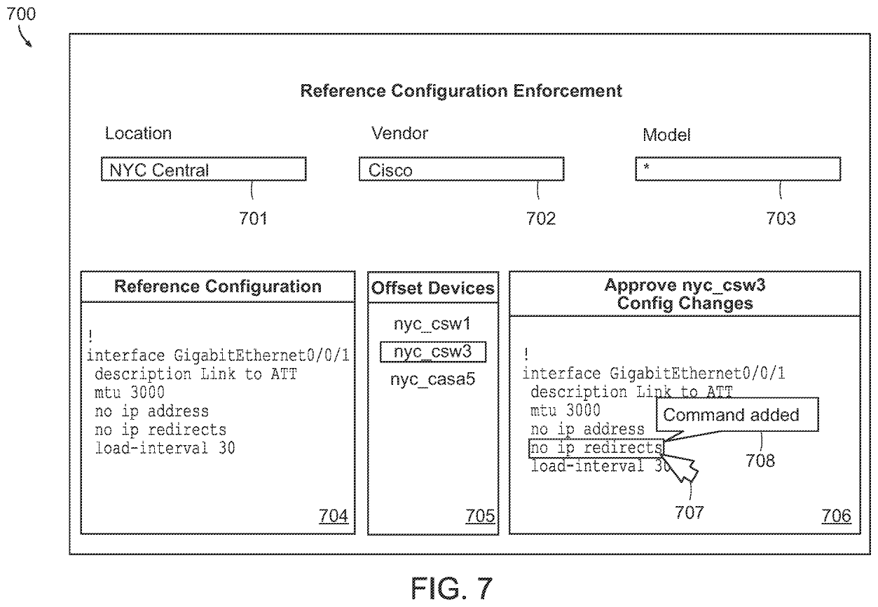

FIG. 7 illustrates an example graphical user interface 700 for reference configuration enforcement. As shown, the graphical user interface 700 includes input fields 701 to 703 that allow a user of the graphical user interface 700 (e.g., a network administrator) to specify a site location, a constituent device vendor, and a constituent device model respectively (e.g., a portion of the network). In some implementations, the interface 700 can include additional input fields to allow users to specify devices and/or configurations for analysis using the token array analysis techniques described above. Based on the information provided to input fields 701 to 703, graphical user interface 700 can display, in a reference configuration window 704, one or more reference configurations that are desired for deployment to one or more of the constituent devices. And, based on the information provided to input fields 701 to 703, the graphical user interface 700 can display, in an offset devices window 705, a listing of one or more constituent devices needing changes to be in compliance with the one or more reference configurations displayed in the reference configuration window 704. In some implementations, the order in which the one or more constituent devices needing changes are listed in the offset devices window 705 can indicate a ranking or level of prioritization of devices needing modification to be compliant with the reference modification. For example, an amount of discrepancy between the one or more reference configurations and a configuration of the one of more constituent devices needing changes can be determined using one or more of the token array analysis techniques described above, and the constituent devices can be ordered within the offset devices window 705 from those with the greatest degree of discrepancy to those with the least degree of discrepancy and vice versa. For example, as shown in FIG. 7, nyc_csw1 is listed first in the offset devices window 705, which indicates that this device needs the most or least number of configuration changes dependent on how the devices listed in the offset devices window 705 is sorted.

As shown in FIG. 7, the graphical user interface 700 can also include a configuration change window 706 that is configured to display one or more aspects of the configuration that need to be changed for the configuration of one or more of the devices listed in the offset devices window 705. The aspects shown in the configuration change window 706 can be based on a selection, by a user of the graphical user interface 700, of a device in the offset devices window 705. As such, those aspects shown in the configuration change window 706 can correspond to the device selected by the user's interaction with the listing of devices in the offset devices window 705. For example, as shown in FIG. 7, the nyc_csw3 device has been selected (as indicated by the gray shading in offset devices window 705) and aspects of the configuration of the nyc_csw3 device that have been changed to make the device's configuration compliant with the reference configuration displayed in reference configuration window 705 are displayed in configuration change window 706. The changes made to make the device's configuration compliant with the reference configuration are shaded as shown in window 706 (e.g., the description changed to “Link to ATT”, MTU changed to 3000, an entire command “no ip redirects” was added, etc.).

Additionally, in some implementations, the user can hover a cursor 707 over the aspect of the configuration that was changed to obtain additional information about the implemented change. The additional information can characterize the action that was performed on the device's configuration to place the configuration into compliance with the reference configuration. For example, when the user hovers over the aspect with the cursor 707, a pop-up window 708 can be displayed providing the additional information. With reference to the example shown in FIG. 7, the user can hover over the “no ip redirects” command with the cursor 707, and the pop-up window 708 can be displayed indicating that the “no ip redirects” command was added to the configuration of the nyc_csw3 device to place the nyc_csw3 device configuration into compliance with the reference configuration. In some implementations, the window 706 can show proposed changes to device configurations to make the subject device's configuration compliant with the reference configuration, and the graphical user interface 700 can include functionality that allows the user to approve the proposed changes for implementation into the device configuration or reject the proposed changes such that they are not implemented into the device configuration.

In some implementations, one or more aspects of the process 100 described above can be used to provide assistance in configuring a distributed computing network by, for example, providing functionality for security verification. For example, in some implementations, configurations can be verified for presence of security commands that are found elsewhere in the system/network thus would create security holes if omitted from the configurations.

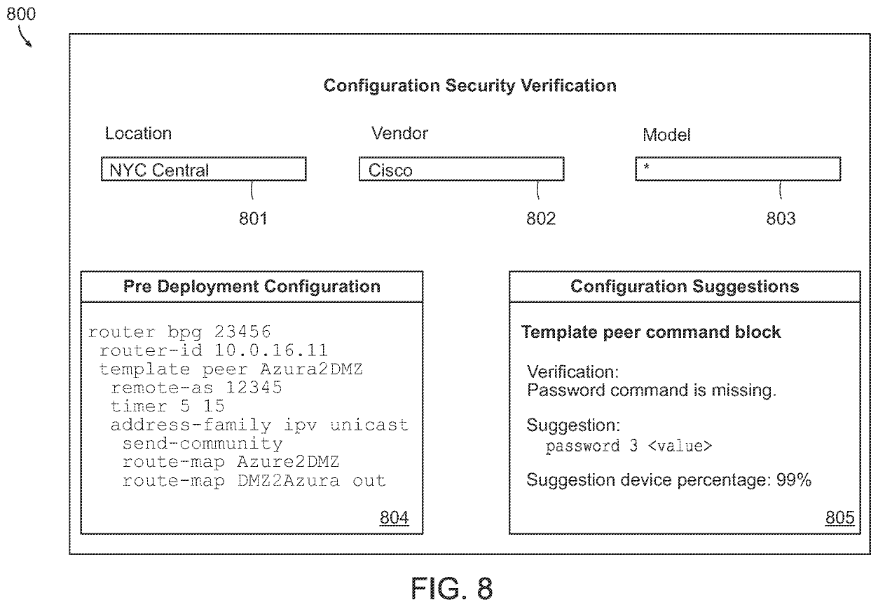

FIG. 8 illustrates an example graphical user interface 800 for configuration security verification. As shown, the graphical user interface 800 includes input fields 801 to 803 that allow a user of the graphical interface (e.g., a network administrator) to specify a site location, a constituent device vendor, and a constituent device model, and respectively. In some implementations, the interface 800 can include additional input fields to allow users to specify devices and/or configurations for analysis using the token array analysis techniques described above. Based on the information provided to input fields 801 to 803, the graphical user interface 800 can display, in a pre-deployment configuration window 804, aspects of the configuration that is to be deployed to the constituent device(s) associated with the provided information. And, the graphical user interface 800 can display, in a configuration suggestions window 805, one or more suggested revisions to the pre-deployment configuration that can result in a minimized risk of misconfiguration.

In some implementations, the suggested revisions can characterize security parameters and/or commands that are analyzed responsive to pre-provided security analysis criteria. For example, a list of corresponding command names of interest, or alternatively a list of key-words of interest (such as “aaa”, “password”, “passwd”, “permit”, “allow”, “deny”, etc.) can be provided as security analysis criteria for use with the token array analysis techniques described above, and the suggested revisions can accordingly be made in cases where the pre-deployment configuration lacked commands and/or parameters responsive to the security analysis criteria.

In some implementations, one or more aspects of the process 100 described above can be used to provide assistance in configuring a distributed computing network by, for example, by allowing users (e.g., network administrators) to query a data store of metrics and parameters produced via the performance of the process 100. This allows administrators to quickly gain a large span of insights in their system/network, discover most frequent configuration values, discover outliers and rare configuration values, and receive a graphical depiction of all values of a given parameter of interest.

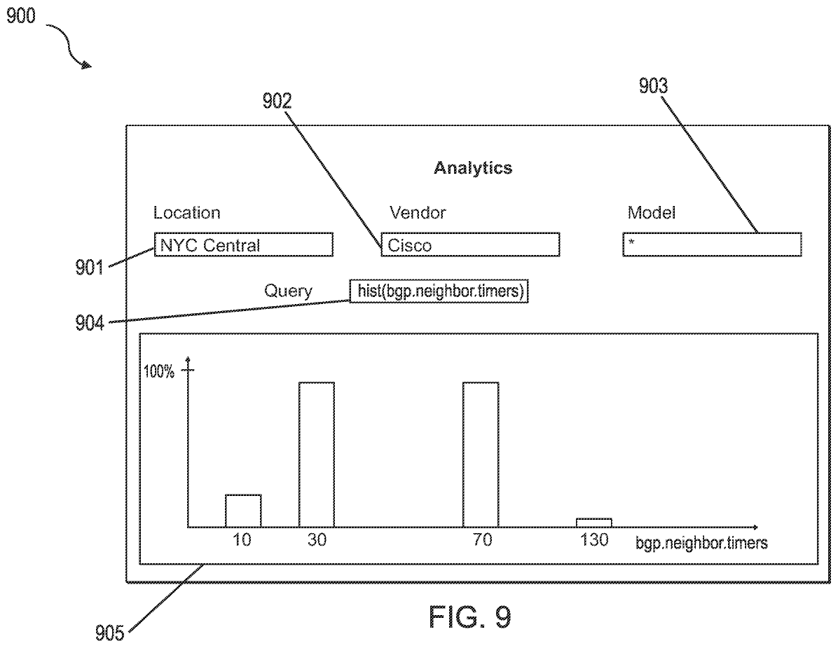

FIG. 9 illustrates an example graphical user interface 900 for configuration security verification. As shown, the graphical user interface 900 includes input fields 901 to 904 that allow a user of the graphical interface (e.g., a network administrator) to specify a site location, a constituent device vendor, a constituent device model, and a query of the commands, metrics and/or parameters described above respectively. Such metrics can indicate degrees of commonality and/or rarity of commands/parameters across configurations of devices characterized by values entered into input fields 901-904.

In some implementations, the interface 900 can include additional input fields to allow users to further specify devices, commands, metrics, and/or configurations for analysis via the interface 900. As shown in FIG. 9, the interface 900 can include an analytics results window 905 that can provide graphically-depicted information characterizing the commands, metrics, and/or parameters provided to input field 904 for those devices characterized by parameters entered into input fields 901-903. As shown in this example, the analytics results window 905 includes a histogram of values for a query for values of the bgp.neighbor.timer parameter in configurations of devices having the parameters specified in input fields 901-903. This can be used to aid a user of the interface 900 in understand which values of bgp.neighbor.timer are most prevalent across the components characterized by the values provided in fields 901-903.

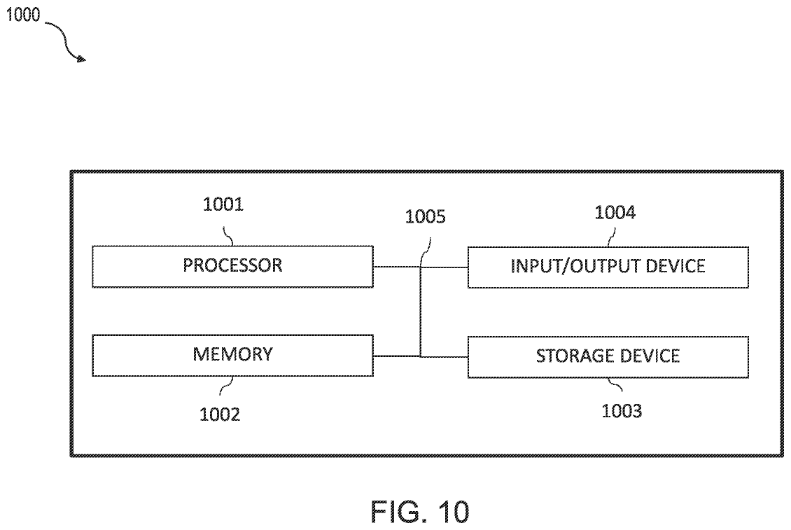

In some implementations, the subject matter described herein can be configured to be implemented in a system 1000, as shown in FIG. 10. The system 1000 can include a processor 1001, a memory 1002, a storage device 1003, and an input/output device 1004. Each of the components 1001, 1002, 1003 and 1004 can be interconnected using a system bus 1005. The processor 1001 can be configured to process instructions for execution within the system 190. In some implementations, the processor 1001 can be a single-threaded processor. In alternate implementations, the processor 1001 can be a multi-threaded processor. The processor 1001 can be further configured to process instructions stored in the memory 1002 or on the storage device 1003, including receiving or sending information through the input/output device 1004. The memory 1002 can store information within the system 190. In some implementations, the memory 1002 can be a computer-readable medium. In alternate implementations, the memory 1002 can be a volatile memory unit. In yet some implementations, the memory 1002 can be a non-volatile memory unit. The storage device 1003 can be capable of providing mass storage for the system 190. In some implementations, the storage device 1003 can be a computer-readable medium. In alternate implementations, the storage device 1003 can be a floppy disk device, a hard disk device, an optical disk device, a tape device, non-volatile solid state memory, or any other type of storage device. The input/output device 1004 can be configured to provide input/output operations for the system 190. In some implementations, the input/output device 1004 can include a keyboard and/or pointing device. In alternate implementations, the input/output device 1004 can include a display unit for displaying graphical user interfaces.

The subject matter described herein can provide several technical advantages. For example, some implementations of the subject matter described herein allow for the determination of modifications to configurations based on commonalities identified in disparate forms of information found on distributed computing network components. As common algorithms do not track many valuable pieces of information found across distributed computing networks, they, unlike the subject matter described herein, cannot identify modifications to configurations that are based on commands and/or parameters commonly found across configurations of portions of a network that differ from configurations of a portion of a network under examination. Additionally, by use of the configuration discrepancy determination techniques described herein, some implementations of the subject matter described herein can provide solutions to determined discrepancies with relatively minimal computational load for the amount of data evaluated (e.g., configurations of numerous devices spread across a vast, distributed computing network) to determine the discrepancies as compared to existing techniques. Accordingly, the subject matter described herein can provide for the determination of optimized distributed network configurations without previous determination of command context or syntax and without prior determination of parameter definitions (and the use of the computational power required to do so).

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person, a computer, and software and/or applications executing on a computer, and the like.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method for optimizing a distributed computing network, comprising:
receiving, by least one processor, first data characterizing one or more constituent devices of the distributed computing network, each of the one or more constituent devices configured with a configuration structure comprising one or more configuration layers;
determining, using the at least one processor, a subset of the one or more constituent devices based on the received first data;
determining, using the at least one processor, second data characterizing at least one configuration discrepancy between each of the one or more constituent devices included in the determined subset, the second data determined by tokenizing one or more commands included in each of the one or more configuration layers used to configure each of the one or more constituent devices included in the determined subset and identifying the at least one configuration discrepancy based on the tokenized one or more commands;
determining, using the at least one processor and based on the tokenized commands, third data characterizing a predominant configuration profile across each of the one or more constituent devices included in the determined subset;
determining, using the at least one processor and based on the second data and third data, one or more modifications to at least one of the one or more configuration layers of the one or more constituent devices;
determining, using the at least one processor and based on the determined one or more modifications, fourth data characterizing a revised configuration of the one or more constituent devices; and
providing, by the at least one processor, the fourth data to a network configuration device to cause the revised configuration to be applied to the one or more constituent devices.

2. The method according to claim 1, wherein the tokenizing of the one or more commands includes determining, for each command of the one or more commands, an array that includes at least one string and at least one value indicating a presence of the command within one of the one or more configuration layers.

3. The method according to claim 1, wherein the identifying of the at least one configuration discrepancy and the determining of the predominant configuration profile includes evaluating the at least one value of the tokenized command.

4. The method according to claim 3, wherein the determination of the one or more modifications is based on the evaluation of the at least one value of the tokenized command.

5. The method according to claim 1, wherein the subset of the one or more constituent devices is determined based on at least one of: a location of the one or more constituent devices, a vendor and model of the one or more constituent devices, a measure of similarity of connections of the one or more constituent devices exceeding a predetermined threshold, and a presence of shared configuration elements.

6. The method according to claim 1, further comprising:
determining a graphical depiction characterizing the at least one configuration discrepancy; and
providing the graphical depiction to a graphical user interface for display therein.

7. The method according to claim 1, wherein the fourth data includes prioritization data characterizing a ranking assigned to one or more portions of the revised configuration, wherein the ranking is based on a rate of occurrence of the at least one configuration discrepancy, and wherein the revised configuration characterized by the fourth data is based on the prioritization data.

8. The method according to claim 1, wherein the at least one configuration discrepancy characterizes an absence of a security command within one or more of the one or more configuration layers.

9. The method according to claim 1, further comprising:
determining, using the at least one processor, a graphical user interface that characterizes the determined one or more modifications and one or more of the one or more configuration layers, and
providing, using the at least one processor, the graphical user interface to a display for depiction thereon.

10. The method according to claim 1, further comprising:
determining, based on the determined one or more modifications, an auto-completion program that is configured to provide a graphical prompt characterizing a second, following portion of the one or more commands in response to the user inputting a first, preceding portion of the one or more commands.

11. A system comprising:
at least one programmable processor; and
a non-transitory machine-readable medium storing instructions that, when executed by the at least one programmable processor, cause the at least one programmable processor to perform operations comprising:
receiving, by least one processor, first data characterizing one or more constituent devices of the distributed computing network, each of the one or more constituent devices configured with a configuration structure comprising one or more configuration layers;
determining, using the at least one processor, a subset of the one or more constituent devices based on the received first data;
determining, using the at least one processor, second data characterizing at least one configuration discrepancy between each of the one or more constituent devices included in the determined subset, the second data determined by tokenizing one or more commands included in each of the one or more configuration layers used to configure each of the one or more constituent devices included in the determined subset and identifying the at least one configuration discrepancy based on the tokenized one or more commands;
determining, using the at least one processor and based on the tokenized commands, third data characterizing a predominant configuration profile across each of the one or more constituent devices included in the determined subset;
determining, using the at least one processor and based on the second data and third data, one or more modifications to at least one of the one or more configuration layers of the one or more constituent devices;
determining, using the at least one processor and based on the determined one or more modifications, fourth data characterizing a revised configuration of the one or more constituent devices; and
providing, by the at least one processor, the fourth data to a network configuration device to cause the revised configuration to be applied to the one or more constituent devices.

12. The system according to claim 11, wherein the tokenizing of the one or more commands includes determining, for each command of the one or more commands, an array that includes at least one string and at least one value indicating a presence of the command within one of the one or more configuration layers.

13. The system according to claim 11, wherein the identifying of the at least one configuration discrepancy and the determining of the predominant configuration profile includes evaluating the at least one value of the tokenized command.

14. The system according to claim 13, wherein the determination of the one or more modifications is based on the evaluation of the at least one value of the tokenized command.

15. The system according to claim 11, wherein the subset of the one or more constituent devices is determined based on at least one of: a location of the one or more constituent devices, a vendor and model of the one or more constituent devices, a measure of similarity of connections of the one or more constituent devices exceeding a predetermined threshold, and a presence of shared configuration elements.

16. The system according to claim 11, further comprising:
determining a graphical depiction characterizing the at least one configuration discrepancy; and
providing the graphical depiction to a graphical user interface for display therein.

17. The system according to claim 11, wherein the fourth data includes prioritization data characterizing a ranking assigned to one or more portions of the revised configuration, and wherein the ranking is based on a rate of occurrence of the at least one configuration discrepancy, and wherein the revised configuration characterized by the fourth data is based on the prioritization data.

18. The system according to claim 11, wherein the at least one configuration discrepancy characterizes an absence of a security command within one or more of the one or more configuration layers.

19. The system according to claim 11, wherein the operations further comprise:
determining, using the at least one processor, a graphical user interface that characterizes the determined one or more modifications and one or more of the one or more configuration layers, and
providing, using the at least one processor, the graphical user interface to a display for depiction thereon.

20. A computer program product comprising a non-transitory machine-readable medium storing instructions that, when executed by at least one programmable processor, cause the at least one programmable processor to perform operations comprising:
receiving, by least one processor, first data characterizing one or more constituent devices of the distributed computing network, each of the one or more constituent devices configured with a configuration structure comprising one or more configuration layers;
determining, using the at least one processor, a subset of the one or more constituent devices based on the received first data;
determining, using the at least one processor, second data characterizing at least one configuration discrepancy between each of the one or more constituent devices included in the determined subset, the second data determined by tokenizing one or more commands included in each of one or more configuration layers used to configure each of the one or more constituent devices included in the determined subset and identifying the at least one configuration discrepancy based on the tokenized one or more commands;
determining, using the at least one processor and based on the tokenized commands, third data characterizing a predominant configuration profile across each of the one or more constituent devices included in the determined subset;
determining, using the at least one processor and based on the second data and third data, one or more modifications to at least one of the one or more configuration layers of the one or more constituent devices;
determining, using the at least one processor and based on the determined one or more modifications, fourth data characterizing a revised configuration of the one or more constituent devices; and
providing, by the at least one processor, the fourth data to a network configuration device to cause the revised configuration to be applied to the one or more constituent devices.
